(19) United States
(12) Patent Application Publication
(10) Pub. No.: US 2006/0264525 A1
(43) Pub. Date: Nov. 23, 2006

(54) Composition for photocatalyst coating and coating film

(75) Inventors: Takeshi Ohwaki, Aichi (JP); Takeshi Morikawa, Aichi (JP); Koyu Aoki, Aichi (JP); Kenichi Suzuki, Aichi (JP); Yasunori Taga, Aichi (JP); Tarou Kanamori, Tokyo (JP); Nakaatsu Yoshimura, Tokyo (JP); Satoshi Ishikawa, Tokyo (JP); Akira Nishikawa, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: JSR Corporation, Tokyo (JP)

(21) Appl. No.: 10/548,483

(22) PCT Filed: Mar. 4, 2004
(86) PCT No.: PCT/JP04/02740

§ 371 Date: Jul. 12, 2006

(30) Foreign Application Priority Data
Mar. 11, 2003 (JP) 2003064756

(51) Int. Cl. C08J 3/28

(52) U.S. Cl. 522/18

(57) ABSTRACT

Photocatalytic coating compositions contain a photocatalytic material such as obtained by doping nitrogen atoms to an interstitial site of metal oxide crystals, a titanium compound having a specific structure, an organosilane hydrolysate having a specific structure, and an organosiloxane oligomer having a specific structure. The photocatalytic coating compositions can give coating films that exhibit adequate photocatalytic action even in an environment with less spectral components having wavelengths of 400 nm or below and more visible light, for example in an indoor environment and in vehicle interiors having UV protection glass, and that have high transparency. Further, the photocatalytic coating compositions have good storage stability of dispersions.

### FIELD OF THE INVENTION

The present invention relates to photocatalytic coating compositions exhibiting photocatalytic action with visible light, and coating films made from the photocatalytic coating compositions.

### BACKGROUND OF THE INVENTION

The present inventors have proposed, as materials exhibiting photocatalytic action in a visible lighted environment, visible light-sensitive photocatalytic materials obtainable by at least one of (i) substituting a nitrogen atom for part of the oxygen sites of metal oxide crystals such as titanium oxide crystal, (ii) doping a nitrogen atom at an interstitial site of lattices of metal oxide crystals such as titanium oxide crystal, and (iii) doping a nitrogen atom between grain boundaries of polycrystalline aggregates of metal oxide crystals such as titanium oxide crystal (WO 01/10552 and JP-A-2001-205094). The photocatalytic materials are semiconductors, absorb visible light to form electrons and holes, and show bactericidal action and catalytic action in various chemical reactions such as decomposition of organic substances.

For the visible light-sensitive photocatalytic material powder to be immobilized on various substrates at low temperatures (for example 200° C. or below) and to exhibit photocatalytic action, it is necessary that the powder form a film excellent in dispersion properties and stability while ensuring the photocatalytic performance. However, powders of the materials obtained by (i) substituting a nitrogen atom for part of the oxygen sites of metal oxide crystals, (ii) doping a nitrogen atom at an interstitial site of lattices of metal oxide crystals, or (iii) doping a nitrogen atom between grain boundaries of polycrystalline aggregates of metal oxide crystals, possess surface characteristics different from those of common metal oxide powders. Accordingly, the conventional coating compositions have had problems in dispersion properties and stability.

Coating materials containing fine metal particles or fine metal oxide particles have wide applications taking advantage of various properties of the fine metal particles or fine metal oxide particles. In particular, silane-based binders compared to organic binders can provide higher durability and are therefore suitably used under conditions of, particularly, exposure to ultraviolet rays or high temperatures. For example, the silane-based coating materials containing fine metal oxide particles are produced as follows:

(1) Fine metal particles or fine metal oxide particles are finely dispersed in a compatible solvent to give a sol, followed by mixing with a silane-based binder.

(2) A hydrolyzable silane as a silane-based binder material, and fine metal particles or fine metal oxide particles are mixed together, and the hydrolyzable silane is polymerized in the presence of the fine metal particles or fine metal oxide particles.

In these methods, however, dispersion stability deteriorates with increase of the content of the fine metal particles or fine metal oxide particles. Consequently, the fine particles often aggregate to deteriorate the transparency of films or to lower the storage stability of dispersions.

### OBJECTS OF THE INVENTION

The present invention aims to solve the aforementioned problems in the art. It is therefore an object of the invention to provide photocatalytic coating compositions that exhibit adequate photocatalytic action even in an environment with less spectral components having wavelengths of 400 nm or below and more visible light, for example in an indoor environment and in vehicle interiors having UV protection glass, and that can give highly transparent films and have good storage stability of dispersions. It is another object of the invention to provide coating films made from the photocatalytic coating compositions.

### DISCLOSURE OF THE INVENTION

The present inventors diligently studied to solve the problems described hereinabove, and have found that photocatalytic coating compositions containing: a photocatalytic material such as obtained by doping a nitrogen atom at an interstitial site of lattices of metal oxide crystals such as titanium oxide crystal; a titanium compound having a specific structure; an organosilane hydrolysate having a specific structure; and an organosiloxane oligomer having a specific structure, can give coating films (hereinafter also referred to “films”) that exhibit adequate photocatalytic action even in an environment with less spectral components having wavelengths of 400 nm or below, for example in a fluorescent-lighted indoor environment and in vehicle interiors having UV protection glass, and that have high transparency. Further, it has been found that the photocatalytic coating compositions have good storage stability of dispersions. The present invention has been completed based on the findings.

A photocatalytic coating composition according to the present invention comprises:

(a) at least one visible light-sensitive photocatalytic material selected from the group consisting of (i) photocatalytic materials obtained by substituting a nitrogen atom for part of the oxygen sites of a metal oxide crystal, (ii) photocatalytic materials obtained by doping a nitrogen atom at an interstitial site of lattices of a metal oxide crystal, and (iii) photocatalytic materials obtained by doping a nitrogen atom between grain boundaries of polycrystalline aggregates of a metal oxide crystal;

(b) at least one titanium compound selected from the group consisting of organotitaniums represented by the following formula (1) and derivatives thereof:
R¹ₘTi(OR²)₄₋ₘ (1)

wherein R¹ is an organic group of 1 to 8 carbon atoms and may be the same or different from each other when plural; R² is an organic group selected from the group consisting of alkyl groups of 1 to 6 carbon atoms, acyl groups of 1 to 6 carbon atoms and phenyl group, and may be the same or different from each other when plural; R¹ and R² may be the same or different; and m is an integer ranging from 0 to 3;

(c) at least one silane compound selected from the group consisting of organosilanes represented by the following formula (2) and derivatives thereof:
R³ₙSi(OR⁴)₄₋ₙ (2)

wherein R³ is a monovalent organic group of 1 to 8 carbon atoms and may be the same or different from each other when plural; R⁴ is an alkyl group of 1 to 5 carbon atoms or an acyl group of 1 to 6 carbon atoms, and may be the same or different from each other when plural; R³ and R⁴ may be the same or different; and n is an integer ranging from 0 to 3;

(d) an organosiloxane oligomer that has an Si-0 linkage and a weight-average molecular weight of 300 to 100,000, said organosiloxane oligomer containing a structure represented by the following formula (3):
—(R⁵O)ₚ—(R⁶O)_{q}—R⁷ (3)

wherein R⁵ and R⁶ are each an alkyl group of 1 to 5 carbon atoms and may be the same or different; R⁷ is a hydrogen atom or an alkyl group of 1 to 5 carbon atoms; and p and q are numbers of which the total (p+q) is in the range of 2 to 50; and

(e) water and/or an organic solvent.

Preferably, the photocatalytic coating composition further comprises a catalyst (f) capable of accelerating hydrolysis and condensation of the silane compound (c). It is also preferable that in the photocatalytic material (a), the nitrogen atom and a metal atom of the metal oxide form a chemical bond.

Preferably, the metal oxide is titanium oxide.

A coating film according to the present invention is obtained from the above photocatalytic coating composition and comprises the photocatalytic material (a), polytitanoxane and polysiloxane.

Preferably, the photocatalytic material (a) is adjacent to the polytitanoxane and is dispersed in the polysiloxane through the polytitanoxane.

### BRIEF DESCRIPTION OF THE DRAWINGS

FIG. 1 is a graph showing the relation between the visible light irradiation time and the carbon dioxide generation, wherein:

A: Nonwoven fabric coated with photocatalytic coating composition A

B: Nonwoven fabric coated with photocatalytic coating composition B

### DESCRIPTION OF THE PREFERRED EMBODIMENTS

Hereinbelow, components of the photocatalytic coating compositions according to the invention will be described in detail.

(a) Photocatalytic Materials:

The photocatalytic material (a) used in the invention is at least one visible light-sensitive photocatalytic material selected from the group consisting of (i) photocatalytic materials obtained by substituting a nitrogen atom for part of the oxygen sites of a metal oxide crystal, (ii) photocatalytic materials obtained by doping a nitrogen atom at an interstitial site of lattices of a metal oxide crystal, and (iii) photocatalytic materials obtained by doping a nitrogen atom between grain boundaries of polycrystalline aggregates of a metal oxide crystal. As used herein, the term “visible light-sensitive photocatalytic materials” means materials that are photoactivated by absorbing visible light to exhibit photocatalytic action.

Examples of the metal oxides include titanium oxide, tin oxide, zinc oxide, strontium titanate, tungsten oxide, zirconium oxide, niobium oxide, iron oxide, copper oxide, iron titanate, nickel oxide, bismuth oxide and silicon oxide. Of these metal oxides, titanium oxide is particularly preferable.

The photocatalytic material (a) is preferably a visible light-sensitive photocatalytic material that contains a nitrogen atom in crystal lattices of the metal oxide and in which the nitrogen atom and metal atom of the metal oxide form a chemical bond. The chemical bond between the metal atom and the nitrogen atom, for example, a structure in which some of the oxygen sites of metal oxide crystal are substituted with nitrogen atoms, provides a more stable crystal structure and enables the photocatalytic material to show photocatalytic performance stably over a longer period of time.

The photocatalytic material (a) may be powder, an aqueous sol or colloid by dispersing in water, or an organic solvent-based sol or colloid by dispersing in a polar solvent such as alcohol or a nonpolar solvent such as toluene. When the photocatalytic material (a) is an organic solvent-based sol or colloid, it may be further diluted with water or an organic solvent depending on the dispersibility of photocatalytic material, and the surface of the photocatalytic material (a) may be treated to enhance the dispersibility. The primary particle diameter of the photocatalytic material (a) is desirably not more than 200 nm, preferably not more than 100 nm. Any primary particle diameters exceeding this range can lead to less transparent films.

The photocatalytic material (a), for example that in which the metal oxide is titanium oxide, may be produced by any of the following processes:

(I) Titanium oxide or hydrated titanium oxide is heat-treated in an atmosphere containing at least one gas selected from the group consisting of ammonia gas, nitrogen gas and a nitrogen-hydrogen mixed gas.

(II) A titanium alkoxide solution is heat-treated in an atmosphere containing at lease one gas selected from the group consisting of ammonia gas, nitrogen gas and a nitrogen-hydrogen mixed gas.

(III) In an emulsion combustion method, spray combustion of an emulsion is performed in an atmosphere in which: (1) nitrogen-containing ions or molecules (except nitrate ion) such as ammonia and hydrazine are present in an aqueous solution or suspension of titanate which is the aqueous phase in the emulsion; and (2) oxygen is introduced into a reactor in an amount not more than that required (hereinafter referred to as the required oxygen amount) for combustion components (including oil and surface active agents) contained in the emulsion to completely burn, and for metal ions or metal compounds contained in the aqueous solution to form a most stable oxide in the air.

(IV) In an emulsion combustion method, spray combustion of an emulsion is performed in an atmosphere in which: (1) nitrogen-containing ions or molecules (except nitrate ion) such as ammonia and hydrazine are absent in an aqueous solution or suspension of titanate which is the aqueous phase of the emulsion; and (2) a nitrogen-containing gas (except nitrogen gas) such as ammonia is contained, and oxygen is introduced into a reactor in an amount less than the required oxygen amount.

(V) Titanium nitride crystal or titanium oxynitride crystal is heat-treated or plasma-treated in an oxidation atmosphere containing oxygen, ozone, water molecules or a hydroxyl group-containing compound.

(VI) A mixture of titanium oxide and a nitrogen compound that adsorbs to titanium oxide at ordinary temperature is heated.

The photocatalytic material (a) containing at least one metal oxide selected from the group consisting of tin oxide, zinc oxide, strontium titanate, tungsten oxide, zirconium oxide, niobium oxide, iron oxide, copper oxide, iron titanate, nickel oxide, bismuth oxide and silicon oxide, can be prepared using the actual metal oxide, or a hydroxide, alkoxide or salt of the metal.

The photocatalytic coating composition desirably contains the photocatalytic material (a) in an amount of 1 to 90 wt %, preferably 15 to 85 wt %, more preferably 25 to 80 wt % based on the total solid content of the composition. When the amount of the photocatalytic material (a) based on the total solid content of the composition is less than the lower limit, the photocatalytic coating composition sometimes fails to exert photocatalytic action. When the amount exceeds the upper limit, film-forming properties may be deteriorated with occurrence of chalking or the like in production of coating films.

(b) Titanium Compound:

The titanium compound (b) used in the invention is at least one titanium compound selected from the group consisting of organotitaniums represented by the following formula (1) and derivatives thereof:
R¹ₘTi(R²)₄₋ₘ (1)

wherein R¹ is an organic group of 1 to 8 carbon atoms and may be the same or different from each other when plural; R² is an organic group selected from the group consisting of alkyl groups of 1 to 6 carbon atoms, acyl groups of 1 to 6 carbon atoms and phenyl group, and may be the same or different from each other when plural; R¹ and R² may be the same or different; and m is an integer ranging from 0 to 3.

Examples of the organotitaniums and derivatives thereof include titanium alcoholates, titanium acylates and derivatives thereof. The titanium alcoholate derivatives include hydrolysates, condensates and chelates of the titanium alcoholates, and hydrolysates and condensates of the titanium alcoholate chelates.

The titanium acylate derivatives include hydrolysates, condensates and chelates of the titanium acylates, and hydrolysates and condensates of the titanium acylate chelates.

In the formula (1), R¹ denotes an organic group of 1 to 8 carbon atoms. Specific examples thereof include:

alkyl groups such as methyl, ethyl, n-propyl, i-propyl, n-butyl, sec-butyl, t-butyl, n-pentyl, n-hexyl, n-heptyl, n-octyl and 2-ethylhexyl groups;

acyl groups such as formyl, acetyl, propionyl, butyryl, valeryl, benzoyl, toluoyl and caproyl groups; and

vinyl, allyl, cyclohexyl, phenyl, epoxy, glycidyl, (meth)acryloxy, ureido, amido, fluoroacetamido and isocyanato groups.

Examples of R¹ further include substitution derivatives of the above organic groups. The substituents in the substitution derivatives indicated by R¹ include halogen atoms, substituted or unsubstituted amino group, hydroxyl group, mercapto group, isocyanato group, glycidoxy group, 3,4-epoxycyclohexyl group, (meth)acryloxy group, ureido group and ammonium bases. Preferably, the substitution derivative as R¹ has up to 8 carbon atoms including those of the substituent.

When plural, R¹ in the formula (1) may be the same or different from each other.

The alkyl groups of 1 to 6 carbon atoms indicated by R² include methyl, ethyl, n-propyl, i-propyl, n-butyl, i-butyl, sec-butyl, t-butyl, n-hexyl, n-heptyl, n-octyl and 2-ethylhexyl groups.

The acyl groups of 1 to 6 carbon atoms indicated by R² include formyl, acetyl, propionyl, butyryl, valeryl, benzoyl, toluoyl and caproyl groups.

When plural, R² in the formula (1) may be the same or different from each other.

The titanium alcoholate chelate can be obtained by reacting the titanium alcoholate with at least one compound (hereinafter, the chelating agent) selected from the group consisting of β-diketones, β-ketoesters, hydroxycarboxylic acids, hydroxycarboxylic acid salts, hydroxycarboxylates, ketoalcohols and aminoalcohols. The titanium acylate chelate can be obtained by reacting the titanium acylate with the chelating agent. Of the above chelating agents, the β-diketones and β-ketoesters are preferably used. Specific examples thereof include acetylacetone, methyl acetoacetate, ethyl acetoacetate, n-propyl acetoacetate, i-propyl acetoacetate, n-butyl acetoacetate, sec-butyl acetoacetate, t-butyl acetoacetate, 2,4-hexane-dione, 2,4-heptane-dione, 3,5-heptane-dione, 2,4-octane-dione, 2,4-nonane-dione and 5-methyl-hexane-dione.

Specific examples of the titanium alcoholates and chelates thereof include tetra-i-propoxytitanium, tetra-n-butoxytitanium, tetra-t-butoxytitanium, di-i-propoxy bis(ethyl acetoacetato)titanium, di-i-propoxy bis(acetyl acetato)titanium, di-i-propoxy bis(lactato)titanium, di-i-propoxy bis(acetylacetonato)titanium, di-n-butoxy bis(triethanolaminato) titanium, di-n-butoxy bis(acetylacetonato)titanium and tetrakis(2-ethylhexyloxy)titanium.

Of these, preferred are tetra-i-propoxytitanium, tetra-n-butoxytitanium, tetra-t-butoxytitanium, di-i-propoxy bis(acetylacetonato)titanium and di-n-butoxy bis(acetylacetonato)titanium.

Specific examples of the titanium acylates and chelates thereof include dihydroxy titanium dibutylate, di-i-propoxy titanium diacetate, bis(acetylacetonato) titanium diacetate, bis(acetylacetonato) titanium dipropionate, di-i-propoxy titanium dipropionate, di-i-propoxy titanium dimalonate, di-i-propoxy titanium dibenzoylate, di-n-butoxy zirconium diacetate and di-i-propylaluminum monomalonate. Of these, dihydroxy titanium dibutylate and di-i-propoxy titanium diacetate are preferred.

The hydrolysates of the titanium alcoholates, titanium alcoholate chelates, titanium acylates and titanium acylate chelates each may be obtained by hydrolyzing at least one OR² group in the titanium alcoholate or titanium acylate. For example, the hydrolysate may be obtained by hydrolyzing one OR² group or by hydrolyzing two or more OR² groups, or may be a mixture thereof.

The condensates of the titanium alcoholates, titanium alcoholate chelates, titanium acylates and titanium acylate chelates are each obtained by condensing the Ti—OH groups in the hydrolysates of the titanium alcoholate, titanium alcoholate chelate, titanium acylate and titanium acylate chelate, to form a Ti—O—Ti linkage. In the present invention, it is not necessary that all the Ti—OH groups be condensed. The condensates include those that are given by condensing a few of the Ti—OH groups, those that are given by condensing most of (or all) the Ti—OH groups, and mixtures of condensates in which both Ti—OR groups and Ti—OH groups are present.

In the invention, the condensate is more preferable for use as the titanium compound (b) because reactivity can be controlled to inhibit gelation. Particularly preferably, the condensate has a condensation degree ranging from dimers to decamers. The condensate used may be obtained by previously hydrolyzing and condensing one titanium compound or a mixture of two or more titanium compounds selected from the titanium alcoholates, titanium alcoholate chelates, titanium acylates and titanium acylate chelates. Commercially available condensates are also employable. The titanium alcoholate condensate or the titanium acylate condensate may be used as it is, or after partial or complete hydrolysis of the OR² groups in the condensate. Alternatively, after the above condensate may be reacted with the chelating agent, the resultant condensate of the titanium alcoholate chelate or the titanium acylate chelate may be used.

Examples of the commercially available titanium alcoholate condensates (ranging from dimers to decamers) include A-10, B-2, B-4, B-7 and B-10 available from NIPPON SODA CO., LTD.

The titanium compounds (b) may be used singly or in combination of two or more kinds.

Desirably, the titanium compound (b) will be contained in an amount of 1 to 50 parts by weight, preferably 2 to 45 parts by weight, more preferably 3 to 40 parts by weight in terms of completely hydrolyzed condensate, per 100 parts by weight of the solid content of the photocatalytic material (a). As used herein, the completely hydrolyzed condensate means the titanium compound of the formula (1) in which the OR² groups are 100% hydrolyzed to form Ti—OH groups and then the Ti—OH groups are all condensed into Ti—O—Ti structures.

The titanium compound (b) probably has functions to reduce diameters of the dispersed particles of the photocatalytic material (a) and to enhance dispersibility of the particles by adsorbing and combining to the surface of the photocatalytic material (a).

(c) Silane Compound:

The silane compound (c) used in the invention is at least one silane compound selected from the group consisting of organosilanes represented by the following formula (2) (hereinafter, the organosilanes (2)) and derivatives thereof:
R³Si (OR⁴)₄₋ₙ (2)

wherein R³ is a monovalent organic group of 1 to 8 carbon atoms and may be the same or different from each other when plural; R⁴ is an alkyl group of 1 to 5 carbon atoms or an acyl group of 1 to 6 carbon atoms, and may be the same or different from each other when plural; R³ and R⁴ may be the same or different; and n is an integer ranging from 0 to 3.

The derivatives of the organosilanes (2) include hydrolysates and condensates of the organosilanes (2).

The silane compound (c) used in the invention is at least one silane compound selected from the group consisting of the organosilanes (2), the hydrolysates of the organosilanes (2) and the condensates of the organosilanes (2). Of these three types of the silane compounds, employable are only one type of the silane compound, or arbitrary two types or all the three types of the silane compounds in combination.

In the formula (2), R³ refers to a monovalent organic group of 1 to 8 carbon atoms. Specific examples thereof include:

alkyl groups such as methyl, ethyl, n-propyl, i-propyl, n-butyl, i-butyl, sec-butyl, t-butyl, n-hexyl, n-heptyl, n-octyl and 2-ethylhexyl groups;

acyl groups such as formyl, acetyl, propionyl, butyryl, valeryl, benzoyl, toluoyl and caproyl groups; and

vinyl, allyl, cyclohexyl, phenyl, epoxy, glycidyl, (meth)acryloxy, ureido, amido, fluoroacetamido and isocyanato groups.

Examples of R³ further include substitution derivatives of the above organic groups. The substituents in the substitution derivatives indicated by R³ include halogen atoms, substituted or unsubstituted amino group, hydroxyl group, mercapto group, isocyanato group, glycidoxy group, 3,4-epoxycyclohexyl group, (meth)acryloxy group, ureido group and ammonium bases. Preferably, the substitution derivative as R³ has up to 8 carbon atoms including those of the substituents.

When plural, R³ in the formula (2) may be the same or different from each other.

The alkyl groups of 1 to 5 carbon atoms indicated by R⁴ include methyl, ethyl, n-propyl, i-propyl, n-butyl, sec-butyl, t-butyl and n-pentyl groups. The acyl groups of 1 to 6 carbon atoms include formyl, acetyl, propionyl, butyryl, valeryl and caproyl groups.

The acyl groups of 1 to 6 carbon atoms indicated by R² include the acyl groups of 1 to 6 carbon atoms described for the titanium compounds (b).

When plural, R⁴ in the formula (2) may be the same or different from each other.

Specific examples of the organosilanes (2) include:

tetraalkoxysilanes such as tetramethoxysilane, tetraethoxysilane, tetra-n-propoxysilane, tetra-i-propoxysilane and tetra-n-butoxysilane;

trialkoxysilanes such as methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, n-butyltrimethoxysilane, n-butyltriethoxysilane, n-pentyltrimethoxysilane, n-hexyltrimethoxysilane, n-heptyltrimethoxysilane, n-octyltrimethoxysilane, vinyltrimethoxysilane, vinyltriethoxysilane, cyclohexyltrimethoxysilane, cyclohexyltriethoxysilane, phenyltrimethoxysilane, phenyltriethoxysilane, 3-chloropropyltrimethoxysilane, 3-chloropropyltriethoxysilane, 3,3,3-trifluoropropyltrimethoxysilane, 3,3,3-trifluoropropyltriethoxysilane, 3-aminopropyltrimethoxysilane, 3-aminopropyltriethoxysilane, 2-hydroxyethyltrimethoxysilane, 2-hydroxyethyltriethoxysilane, 2-hydroxypropyltrimethoxysilane, 2-hydroxypropyltriethoxysilane, 3-hydroxypropyltrimethoxysilane, 3-hydroxypropyltriethoxysilane, 3-mercaptopropyltrimethoxysilane, 3-mercaptopropyltriethoxysilane, 3-isocyanatopropyltrimethoxysilane, 3-isocyanatopropyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-(meth)acryloxypropyltrimethoxysilane, 3-(meth)acryloxypropyltriethoxysilane, 3-ureidopropyltrimethoxysilane and 3-ureidopropyltriethoxysilane;

dialkoxysilanes such as dimethyldimethoxysilane, dimethyldiethoxysilane, diethyldimethoxysilane, diethyldiethoxysilane, di-n-propyldimethoxysilane, di-n-propyldiethoxysilane, di-i-propyldimethoxysilane, di-i-propyldiethoxysilane, di-n-butyldimethoxysilane, di-n-butyldiethoxysilane, di-n-pentyldimethoxysilane, di-n-pentyldiethoxysilane, di-n-hexyldimethoxysilane, di-n-hexyldiethoxysilane, di-n-heptyldimethoxysilane, di-n-heptyldiethoxysilane, di-n-octyldimethoxysilane, di-n-octyldiethoxysilane, di-n-cyclohexyldimethoxysilane, di-n-cyclohexyldiethoxysilane, diphenyldimethoxysilane and diphenyldiethoxysilane;

monoalkoxysilanes such as trimethylmethoxysilane, trimethylethoxysilane, triethylmethoxysilane and triethylethoxysilane; and

methyltriacetyloxysilane and dimethyldiacetyloxysilane.

Of these silane compounds, the trialkoxysilanes and the dialkoxysilanes are preferable. More preferred trialkoxysilanes are methyltrimethoxysilane and methyltriethoxysilane, and more preferred dialkoxysilanes are dimethyldimethoxysilane and dimethyldiethoxysilane.

The organosilanes (2) may be used singly or in combination of two or more kinds. Use of the trialkoxysilane alone or a mixture of 40-95 mol % trialkoxysilane and 60-5 mol % dialkoxysilane is particularly preferable. The combined use of the dialkoxysilane and trialkoxysilane leads to coating films having flexibility and improved alkali resistance.

The silane compound (c) used in the present invention may be the organosilane (2) as it is, or the hydrolysate and/or condensate thereof.

The hydrolysate of the organosilanes (2) may be obtained by hydrolyzing at least one of the two to four OR⁴ groups in the organosilane (2). For example, the hydrolysate may be obtained by hydrolyzing one OR⁴ group or by hydrolyzing two or more OR⁴ groups, or may be a mixture thereof.

The condensates of the organosilanes (2) are each obtained by condensing the silanol groups in the hydrolysate of the organosilane (2) to form an Si—O—Si linkage. In the present invention, it is not necessary that all the silanol groups be condensed. The condensates include those that are given by condensing a few of the silanol groups, those that are given by condensing most of (or all) the silanol groups, and mixtures thereof.

The hydrolysate and/or condensate of the organosilane (2) can be produced by previously subjecting the organosilane (2) to hydrolysis and condensation. Alternatively, as described later, the organosilane (2) can be hydrolyzed with water and be condensed during preparation of the photocatalytic coating composition, thereby to produce the hydrolysate and/or the condensate of the organosilane (2). The hydrolysis may be performed by separately adding water or by using water contained in the photocatalytic material (a) or (e) water or organic solvent described later. The amount of water is usually from 0.5 to 3 mol, preferably from 0.7 to 2 mol per mol of the organosilane (2).

The condensate of the organosilane (2) preferably has a weight-average molecular weight in terms of polystyrene (hereinafter, “Mw”) from 300 to 100,000, more preferably from 500 to 50,000.

The silane compound (c) used in the invention may be prepared as described above, or may be commercially available silane compounds. Examples of the commercial silane compounds include MKC silicate available from Mitsubishi Chemical Corp., ethyl silicate available from COLCOAT Co., Ltd., silicone resins available from Dow Corning Toray Silicone Co., Ltd., silicone resins available from GE Toshiba Silicones, silicone resins available from Shin-Etsu Chemical Co., Ltd., hydroxyl group-containing polydimethylsiloxanes available from Dow Corning Asia Ltd., and silicone oligomers available from Nippon Unicar Co., Ltd. These commercial silane compounds may be used directly or after condensed.

The silane compounds (c) may be used singly or in combination of two or more kinds.

Desirably, the silane compound (c) will be contained in an amount of 5 wt % or above, preferably 10 wt % or above, more preferably 20 wt % or above in terms of completely hydrolyzed condensate, based on the solids other than the photocatalytic material (a) in the photocatalytic coating composition. As used herein, the completely hydrolyzed condensate means the silane compound of the formula (2) in which the OR⁴ groups are 100% hydrolyzed into Si—OH groups and then the Si—OH groups are all condensed to form siloxane structures. When the amount of the silane compound (c) is below the lower limit, the resultant coating film sometimes becomes brittle and suffers chalking.

(d) Organosiloxane Oligomer:

The organosiloxane oligomer (d) used in the invention has an Si—O linkage and a weight-average molecular weight of 300 to 100,000. Also, the oligomer (d) has a structure represented by the following formula (3) at its side chain and/or terminal:
—(R⁵O)—(R⁶O)—R⁷ (3)

wherein R⁵ and R⁶ are each an alkyl group of 1 to 5 carbon atoms; R⁷ is a hydrogen atom or an alkyl group of 1 to 5 carbon atoms; and p and q are numbers of which the total (p+q) is 2 to 50.

The functional groups represented by the above formula (3) include polyoxyalkylene groups such as polyoxyethylene, polyoxypropylene and poly(oxyethylene/oxypropylene). When the organosiloxane oligomer (d) contains this functional group, the polyoxyalkylene group in the functional group is liable to adsorb to the photocatalytic material (a) to improve dispersion stability of the photocatalytic material (a).

The main chain of the organosiloxane oligomer (d) may be substituted with a functional group that contains a hydroxyl group, a halogen atom or an organic group of 1 to 15 carbon atoms.

The halogen atoms include fluorine and chlorine.

The organic groups of 1 to 15 carbon atoms include alkyl, acyl, alkoxyl, alkoxysilyl, vinyl, allyl, acetoxyl, acetoxysilyl, cycloalkyl, phenyl, glycidyl, (meth)acryloxy, ureido, amido, fluoroacetamido and isocyanato groups.

The alkyl groups of 1 to 15 carbon atoms include methyl, ethyl, n-propyl, i-propyl, n-butyl, i-butyl, sec-butyl, t-butyl, n-hexyl, n-heptyl, n-octyl, n-nonyl, n-decyl, undecyl, dodecyl, tridecyl, tetradecyl, hexadecyl, heptadecyl, octadecyl and 2-ethylhexyl groups.

The acyl groups of 1 to 15 carbon atoms include formyl, acetyl, propionyl, butyryl, valeryl, benzoyl and toluoyl groups.

The alkoxyl groups of 1 to 15 carbon atoms include methoxy, ethoxy, propoxy and butoxy groups.

The alkoxysilyl groups of 1 to 15 carbon atoms include methoxysilyl, ethoxysilyl, propoxysilyl and butoxysilyl groups.

These groups may be partially hydrolyzed and condensed. Substitution derivative of the above group is also employable. The substituents of the substitution derivatives include halogen atoms, substituted or unsubstituted amino group, hydroxyl group, mercapto group, isocyanato group, glycidoxy group, 3,4-epoxycyclohexyl group, (meth)acryloxy group, ureido group, ammonium bases and ketoester group.

Of the organosiloxane oligomers (d), particularly preferred are those having a structure in which the silicon atom in the silyl group is combined with a hydrolyzable group and/or a hydroxyl group. For example, chlorosilane condensates and alkoxysilane condensates are preferable. When the photocatalytic coating composition of the invention is cured, the organosiloxane oligomer (d) is co-condensed with the titanium compound (b) and the silane compound (c) and is immobilized to give a stable coating film.

The organosiloxane oligomer (d) has a weight-average molecular weight in terms of polystyrene (hereinafter “Mw”) from 300 to 100,000, preferably from 600 to 50,000. When the weight-average molecular weight is below the lower limit, the resultant coating film sometimes has insufficient flexibility. When it exceeds the upper limit, the storage stability of the coating composition is sometimes deteriorated.

The organosiloxane oligomers (d) may be used singly or in combination of two or more kinds. Exemplary combinations of two or more organosiloxane oligomers (d) are mixtures of an organosiloxane oligomer having Mw of 400 to 2,800 and an organosiloxane oligomer having Mw of 3,000 to 50,000, and mixtures of two organosiloxane oligomers having different functional groups.

In the invention, commercially available organosiloxane oligomer is employable as the organosiloxane oligomer (d). Examples thereof include modified silicone oils available from Dow Corning Toray Silicone Co., Ltd., modified silicone oils available from GE Toshiba Silicones, modified silicone oils available from Shin-Etsu Chemical Co., Ltd., and modified silicone oligomers available from Nippon Unicar Co., Ltd. These organosiloxane oligomers may be used as they are or as condensates.

Desirably, the organosiloxane oligomer (d) will be contained in an amount of 1 to 200 parts by weight, preferably 5 to 100 parts by weight, more preferably 10 to 80 parts by weight per 100 parts by weight of the solid content of the photocatalytic material (a). When the amount of the organosiloxane oligomer (d) is below the lower limit, dispersion stability is sometimes poor. When it exceeds the upper limit, the resultant coating film sometimes becomes brittle and suffers chalking.

(e) Water and/or Organic Solvent:

The photocatalytic coating composition of the invention contains (e) water and/or an organic solvent. Herein, known organic solvents can be used, and examples thereof include alcohols, aromatic hydrocarbons, ethers, ketones and esters.

The alcohols include methanol, ethanol, n-propyl alcohol, i-propyl alcohol, n-butyl alcohol, sec-butyl alcohol, t-butyl alcohol, n-hexyl alcohol, n-octyl alcohol, ethylene glycol, diethylene glycol, triethylene glycol, ethylene glycol monobutyl ether, ethylene glycol monoethyl ether acetate, diethylene glycol monoethyl ether, propylene glycol monomethyl ether, propylene monomethyl ether acetate and diacetone alcohol.

The aromatic hydrocarbons include benzene, toluene and xylene.

The ethers include tetrahydrofuran and dioxane.

The ketones include acetone, methyl ethyl ketone, methyl isobutyl ketone and diisobutyl ketone.

The esters include ethyl acetate, propyl acetate, butyl acetate, propylene carbonate, methyl lactate, ethyl lactate, normal propyl lactate, isopropyl lactate, methyl 3-ethoxypropionate and ethyl 3-ethoxypropionate.

These organic solvents may be used singly or in combination of two or more kinds.

(f) Catalyst:

Preferably, the photocatalytic coating composition of the invention further contains a catalyst (f) capable of accelerating hydrolysis and condensation of the silane compound (c). Employable catalysts (f) include acidic compounds, alkaline compounds, salt compounds, amine compounds, and organometallic compounds and/or partial hydrolysates thereof (hereinafter, the organometallic compounds and/or partial hydrolysates thereof will be collectively referred to as the “organometallic compounds”).

The acidic compounds include acetic acid, hydrochloric acid, sulfuric acid, phosphoric acid, alkyltitanic acid, p-toluenesulfonic acid and phthalic acid. Of these acidic compounds, acetic acid is preferable.

The alkaline compounds include sodium hydroxide and potassium hydroxide. Of these alkaline compounds, sodium hydroxide is preferable.

The salt compounds include alkali metal salts of naphthenic acid, octylic acid, nitrous acid, sulfurous acid, aluminic acid and carbonic acid.

The amine compounds include ethylenediamine, hexamethylenediamine, diethylenetriamine, triethylenetetramine, tetraethylenepentamine, piperidine, piperadine, m-phenylenediamine, p-phenylenediamine, ethanolamine, triethylamine, 3-aminopropyl trimethoxysilane, 3-aminopropyl triethoxysilane, 3-(2-aminoethyl)-aminopropyl trimethoxysilane, 3-(2-aminoethyl)-aminopropyl triethoxysilane, 3-(2-aminoethyl)-aminopropyl methyl dimethoxysilane, 3-anilinopropyl trimethoxysilane, alkylamine salts, quaternary ammonium salts. Further, modified amines used as curing agents for epoxy resins are also employable. Of these amine compounds, 3-aminopropyl trimethoxysilane, 3-aminopropyl triethoxysilane and 3-(2-aminoethyl)-aminopropyl trimethoxysilane are preferred.

The organometallic compounds include:

compounds represented by the following formula (4) (hereinafter, the organometallic compounds (4)):
M(OR⁸)ᵣ(R⁹COCHCOR¹⁰) (4)

wherein M denotes at least one metal atom selected from zirconium, titanium and aluminum; R⁸ and R⁹ are each a monovalent hydrocarbon group of 1 to 6 carbon atoms such as ethyl, n-propyl, i-propyl, n-butyl, sec-butyl, t-butyl, n-pentyl, n-hexyl, cyclohexyl or phenyl group; R¹⁰ is the monovalent hydrocarbon group of 1 to 6 carbon atoms, or an alkoxyl group of 1 to 16 carbon atoms such as methoxy, ethoxy, n-propoxy, i-propoxy, n-butoxy, sec-butoxy, t-butoxy, lauryloxyorstearyloxy group; and r and s are each an integer of 0 to 4, and (r+s)=(valency of M);

tetravalent organotin compounds in which 1 to 2 alkyl groups having 1 to 10 carbon atoms are combined to one tin atom (hereinafter, the organotin compounds); and

partial hydrolysates of these compounds.

The above-described titanium compound (b) is also usable as the organometallic compound.

Examples of the organometallic compounds (4) include:

organozirconium compounds such as tetra-n-butoxy zirconium, tri-n-butoxy ethylacetoacetate zirconium, di-n-butoxy bis(ethylacetoacetate)zirconium, n-butoxy tris(ethylacetoacetate)zirconium, tetrakis(n-propylacetoacetate)zirconium, tetrakis(acetylacetoacetate)zirconium and tetrakis(ethylacetoacetate)zirconium;

organotitanium compounds such as tetra-i-propoxy titanium, di-i-propoxy bis(ethylacetoacetate) titanium, di-i-propoxy bis(acetylacetate) titanium and di-i-propoxy bis(acetylacetone) titanium; and

organoaluminum compounds such as tri-i-propoxy aluminum, di-i-propoxy ethylacetoacetate aluminum, di-i-propoxy acetylacetonate aluminum, i-propoxy bis(ethylacetoacetate) aluminum, i-propoxy bis(acetylacetonate) aluminum, tris(ethylacetoacetate) aluminum, tris(acetylacetonate) aluminum and monoacetylacetonate bis(ethylacetoacetate) aluminum.

Of the organometallic compounds (4) and partial hydrolysates thereof, preferred are tri-n-butoxy ethylacetoacetate zirconium, di-i-propoxy bis(acetylacetonate) titanium, di-i-propoxy ethylacetoacetate aluminum, tris(ethylacetoacetate) aluminum and partial hydrolysates thereof.

Examples of the organotin compounds include:

carboxylic acid-based organotin compounds such as (C₄H₉)₂Sn (OCOC₁₁H₂₃)₂, (C₄H₉)₂Sn (OCOCH═CHCOOCH₃)₂, (C₄H₉)₂Sn (OCOCH═CHCOOC₄H₉)₂, (C₈H₁₇)₂Sn (OCOC₈H₁₇)₂, (C₈H₁₇)₂Sn (OCOC₁₁H₂₃)₂, (C₈H₁₇)₂Sn (OCOCH═CHCOOCH₃)₂, (C₈H₁₇)₂Sn(OCOCH═CHCOOC₄H₉)₂, (C₈H₁₇)₂Sn(OCOCH═CHCOOC₈H₁₇)₂, (C₈H₁₇)₂Sn(OCOCH═CHCOOC₁₆H₃₃)₂, (C₈H₁₇)₂Sn(OCOCH═CHCOOC₁₇H₃₅)₂, (C₈H₁₇)₂Sn (OCOCH═CHCOOC₁₈H₃₇)₂, (C₈H₁₇)₂Sn (OCOCH═CHCOOC₂₀H₄₁)₂, 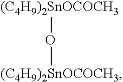
(C₄H₉)Sn(OCOC₁₁H₂₃)₃ and (C₄H₉)Sn(OCONa)₃;

mercaptide-based organotin compounds such as (C₄H₉)₂Sn (SCH₂COOC₈H₁₇)₂, (C₄H₉)₂Sn (SCH₂CH₂COOC₈H₁₇)₂, (C₈H₁₇)₂Sn (SCH₂COOC₈H₁₇)₂, (C₈H₁₇)₂Sn (SCH₂CH₂COOC₈H₁₇)₂, (C₈H₁₇)₂Sn (SCH₂COOC₁₂H₂₅)₂, (C₈H₁₇)₂Sn (SCH₂CH₂COOC₁₂H₂₅)₂, (C₄H₉)Sn(SCOCH═CHCOOC₈H₁₇)₃, (C₈H₁₇)Sn(SCOCH═CHCOOC₈H₁₇)₃ and

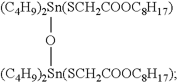

sulfide-based organotin compounds such as (C₄H₉)₂Sn═S, (C₈H₁₇)₂Sn═S and

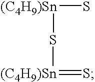

chloride-based organotin compounds such as (C₄H₉)SnCl₃, (C₄H₉)₂SnCl₂, (C₈H₁₇)₂SnCl₂ and

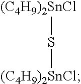

organotin oxides such as (C₄H₉)₂SnO and (C₈H₁₇)₂SnO; and

reaction products formed between the organotin oxide and ester compound such as silicate, dimethyl maleate, diethyl maleate or dioctyl phthalate.

The catalysts (f) may be used singly or in combination of two or more kinds. The catalyst (f) can be used as mixture with a zinc compound or a retarder.

The catalyst (f) may be blended during preparation of the photocatalytic coating composition or may be added to the photocatalytic coating composition during formation of the coating film. It is also possible to add the catalyst (f) during both the preparation of the photocatalytic coating composition and the formation of the coating film.

The amount of the catalyst (f) is desirably not more than 10 mol, preferably in the range of 0.001 to 7 mol, more preferably in the range of 0.001 to 5 mol per mol of the OR⁴ groups in the silane compound (c). When the amount of the catalyst (f) exceeds the upper limit, the storage stability of the photocatalytic coating composition is sometimes deteriorated and the coating film may suffer cracks.

The catalyst (f) accelerates the hydrolysis and condensation of the silane compound (c), the organosiloxane oligomer (d), etc. Therefore, the use of the catalyst (f) leads to an increased molecular weight of the polysiloxane resin resulting from polycondensation of the organosiloxane oligomer (d). Thus, the curing rate for the coating film can be enhanced and the coating film obtained have high strength and durability. Furthermore, the use of the catalyst (f) permits increasing the thickness of the coating film and easy application work.

(g) Stability Improvers:

The photocatalytic coating composition of the invention may contain a stability improver (g) as required. The stability improver (g) is at least one compound selected from the group consisting of β-diketones by the following formula (5), β-ketoesters, carboxylic acid compounds, dihydroxy compounds, amine compounds and oxyaldehyde compounds:
R¹¹COCH₂COR¹² (5)

wherein R¹¹ is a monovalent hydrocarbon group of 1 to 6 carbon atoms such as ethyl, n-propyl, i-propyl, n-butyl, sec-butyl, t-butyl, n-pentyl, n-hexyl, cyclohexyl or phenyl group; R¹² denotes the monovalent hydrocarbon group of 1 to 6 carbon atoms, or an alkoxyl group of 1 to 16 carbon atoms such as methoxy, ethoxy, n-propoxy, i-propoxy, n-butoxy, sec-butoxy, t-butoxy, lauryloxy or stearyloxy group.

Examples of the stability improvers (g) include acetylacetone, methyl acetoacetate, ethyl acetoacetate, n-propyl acetoacetate, i-propyl acetoacetate, n-butyl acetoacetate, sec-butyl acetoacetate, t-butyl acetoacetate, hexane-2,4-dione, heptane-2,4-dione, heptane-3,5-dione, octane-2,4-dione, nonane-2,4-dione, 5-methylhexane-2,4-dione, malonic acid, oxalic acid, phthalic acid, glycolic acid, salicylic acid, aminoacetic acid, iminoacetic acid, ethylenediaminetetraacetic acid, glycol, catechol, ethylenediamine, 2,2-bipyridine, 1,10-phenanthroline, diethylenetriamine, 2-ethanolamine, dimethylglyoxime, dithizone, methionine and salicylaldehyde. Of these stability improvers (g), acetylacetone and ethyl acetoacetate are preferred.

The use of the stability improvers (g) is particularly suitable when the titanium compound (b), or the organometallic compound as the catalyst (f) is used. The stability improvers (g) may be used singly or in combination of two or more kinds.

The use of the stability improver (g) leads to even higher storage stability of the photocatalytic coating compositions. The reason for this effect is probably that the stability improver (g) is coordinated to the metal atoms of the organometallic compound, and this coordination appropriately controls the catalytic action of the organometallic compound in co-condensation of the silane compound (c) and the organosiloxane oligomer (d).

The amount of the stability improver (g) is desirably not less than 2 mol, preferably in the range of 3 to 20 mol per mol of the organometallic compound selected from the aforesaid organometallic compounds. When the amount of the stability improver (g) is below the lower limit, the storage stability may not be improved sufficiently for the photocatalytic coating composition having a high solid concentration.

(h) Other Additive:

The photocatalytic coating composition may contain additives as required. Exemplary additives are:

known dehydrating agents such as methyl orthoformate, methyl orthoacetate and tetraethoxysilane; and

dispersants such as polyoxyethylenealkylether, polyoxyethylenealkylphenylether, polyoxyethylene fatty acid esters, polycarboxylic acid-based high-molecular surfactants, polycarboxylates, polyphosphates, polyacrylates, polyamide ester salts and polyethylene glycol.

Further, a leveling agent may be added for improving coating properties (or film-formation properties) of the compositions of the invention. The leveling agents include:

fluorine leveling agents such as BM1000 and BM1100 (trade names, the same applies hereinafter) available from BM-CHEMIE GmbH, Efka 772 and Efka 777 available from Efka Chemicals B.V., the FLOWLEN series available from Kyoeisha Chemical Co., Ltd., the FC series available from Sumitomo 3M Limited, and the Fluonal (transliteration) TF series available from TOHO Chemical Industry Co., Ltd.;

silicone leveling agents such as the BYK series available from BYK Chemie GmbH, the Sshmego series available from Sshmegmann, and Efka 30, Efka 31, Efka 34, Efka 35, Efka 36, Efka 39, Efka 83, Efka 86 and Efka 88 available from Efka Chemicals B.V.; and

ether or ester leveling agents such as SURFYNOL available from Nisshin Chemical Industry Co., Ltd., and EMULGEN and HOMOGENOL available from Kao Corporation.

The leveling agents improve the appearance of the finished coating films and permit preparing the thin films with uniformity.

In the invention, the leveling agent is preferably used in an amount of 0.01 to 5 wt %, more preferably 0.02 to 3 wt % based on the whole composition.

The leveling agent may be blended during preparation of the photocatalytic coating composition or may be added to the photocatalytic coating composition during formation of the coating film. It is also possible to add the leveling agent during both the preparation of the photocatalytic coating composition and the formation of the coating film.

### Process for Producing Photocatalytic Coating Compositions

In a preferable process for producing the photocatalytic coating compositions, the silane compound (c) may be hydrolyzed and condensed in the presence of at least the photocatalytic material (a), the titanium compound (b) and the organosiloxane oligomer (d). Exemplary processes are given below:

(1) When the Photocatalytic Material (a) is Powder:

To the photocatalytic material (a), the water and/or the organic solvent (e), the titanium compound (b) and the organosiloxane oligomer (d) are added, followed by dispersing with use of a dispersing device or the like. Thereafter, the silane compound (c) and, as required, the water and/or the organic solvent (e), and/or the catalyst (f) are added to perform hydrolysis and condensation.

(2) When the Photocatalytic Material (a) is a Slurry:

To the photocatalytic material (a), the titanium compound (b) and the organosiloxane oligomer (d) are added, followed by stirring. Thereafter, the silane compound (c) and, as required, the water and/or the organic solvent (e), and/or the catalyst (f) are added to perform hydrolysis and condensation.

In the above production processes (1) and (2), each of the components (b) to (f) may be added at once or consecutively. In particular, consecutive addition is preferable for the components having low compatibility with the photocatalytic material (a). As used herein, the term “at-once addition” means that one component is added all at once, whilst the term “consecutive addition” means one component is added over an arbitrary time. When each of the components (b) to (f) is added at once, all of them may be added collectively at once, while they may be added separately in consideration of the compatibility with the photocatalytic material.

The dispersing devices for use in the process (1) include ultrasonic dispersers, ball mills, sand mills (bead mills), homogenizers, ultrasonic homogenizers, nanomizers, propeller mixers and high-shear mixers.

The total solid concentration in the photocatalytic coating compositions is desirably in the range of 1 to 50 wt %, preferably 3 to 40 wt %. Any total solid concentrations exceeding the upper limit may cause deterioration in storage stability.

The photocatalytic coating composition can be prepared appropriately depending on the intended application. For example, it can be used as materials for forming coating films on substrates or as recoating materials for deteriorated coating films.

Coating Films

The coating films according to the present invention can be formed by spreading the aforesaid photocatalytic coating composition on a substrate.

(Substrates)

Suitable substrates include:

metals such as iron, aluminum and stainless steel;

inorganic ceramic materials such as cement, concrete, autoclaved lightweight concrete (ALC), flexible boards, mortar, slate, plaster, ceramics and bricks;

formed articles of plastics such as phenolic resins, epoxy resins, acrylic resins, polyesters, polycarbonates, polyethylenes, polypropylenes, ABS resins (acrylonitrile-butadiene-styrene resins) and thermoplastic norbornene resins;

films and sheets of plastics such as polyethylenes, polypropylenes, polyvinyl alcohols, polycarbonates, polyethylene terephthalates, polyurethanes, polyimides, polyacryl, polyvinyl chloride and thermoplastic norbornene resins;

inorganic materials such as silicon wafers, quartz glass and glass; and

wood materials, paper and nonwoven fabrics.

The substrate may previously be surface-treated for base conditioning, improved adhesion, filling of porous substrates, smoothing, and patterning.

The surface-treatments for the metal substrate include polishing, degreasing, plating, chromate treatment, flame treatment and coupling treatment.

The surface treatments for the plastic substrate include blasting, chemical treatment, degreasing, flame treatment, oxidation treatment, vapor treatment, corona discharge treatment, ultraviolet irradiation treatment, plasma treatment and ion treatment.

The surface treatments for the inorganic ceramic substrate include polishing, filling and patterning.

The surface treatments for the wood substrate include polishing, filling and mothproofing.

The surface treatments for the paper substrate include filling and mothproofing.

The surface treatments for the deteriorated coating film include mechanical or chemical treatments.

Primers may be used to ensure adhesion to the substrate.

(Production of Coating Film)

The coating film according to the invention can be formed by spreading the photocatalytic coating composition on the substrate, followed by drying.

The spreading of the photocatalytic coating composition on the substrate may be performed by application using a brush, a roll coater, a bar coater, a flow coater, a centrifugal coater, an ultrasonic coater or a (micro) gravure coater. Other suitable spreading methods include dip coating, curtain coating, spraying, screen processing, electrodeposition and vapor deposition.

After the photocatalytic coating composition is applied to the substrate by the above method, the coating is dried at ordinary temperature or by heating at a temperature of about 30 to 200° C., generally for 1 to 60 minutes, and hence, stable coating film can be formed.

When the photocatalytic coating composition is applied one time, the dry thickness will be about 0.05 to 20 μm. The coating film formed by double coating will have a dry thickness of about 0.1 to 40 μm.

The coating film according to the present invention contains the photocatalytic material (a), polytitanoxane and polysiloxane. The polytitanoxane is probably derived from the titanium compound (b), and the polysiloxane is probably from the silane compound (c) and/or the organosiloxane oligomer (d) Preferably, the photocatalytic material (a) is adjacent to the polytitanoxane and is dispersed in the polysiloxane through the polytitanoxane.

The bonding of the photocatalytic material (a) with the polysiloxane through the polytitanoxane probably provides functions of reducing diameters of the dispersed particles of the photocatalytic material (a) and enhancing the dispersibility. The polysiloxane has a function of stabilizing the coating film.

The coating film desirably contains the polytitanoxane in an amount of 1 to 50 parts by weight, preferably 2 to 45 parts by weight, more preferably 3 to 40 parts by weight, per 100 parts by weight of the solid content of the photocatalytic material (a). When the amount of the polytitanoxane is less than the lower limit, the bonding stability and dispersibility are sometimes deteriorated. When the amount exceeds the upper limit, photocatalytic functions in the visible light region may be deteriorated. The coating film desirably contains the polysiloxane in an amount of 1 to 200 parts by weight, preferably 5 to 100 parts by weight, more preferably 10 to 80 parts by weight. When the amount of the polysiloxane is less than the lower limit, sufficient dispersion stability may not be obtained. When the amount exceeds the upper limit, the coating film formed may be brittle and suffer chalking.

### EXAMPLES

Hereinbelow, the present invention will be described by Examples. However, it should be construed that the invention is not limited thereto. In Examples and Comparative Examples, part(s) and % are by weight unless otherwise mentioned. The photocatalytic coating compositions were tested by the following methods.

(1) Storage Stability:

The photocatalytic coating composition was stored in sealed polyethylene bottles for one month at ordinary temperature, and was visually observed for gelation. Thereafter, the composition free from gelation was measured for viscosity using a BM viscometer manufactured by Tokyo Keiki Co., Ltd. The storage stability of the photocatalytic coating composition was evaluated by the following criteria:

A: Up to 20% viscosity change between before and after the sealed storage

B: Above 20% viscosity change between before and after the sealed storage

C: Gelation after the sealed storage

(2) Transparency:

The photocatalytic coating composition was diluted with i-propyl alcohol to a solid concentration of 5%, and was applied onto quarts glass with use of ROD. No. 3 bar coater so as to achieve a dry thickness of 0.2 μm, followed by drying at 150° C. for 1 hour. The total light transmittance of the resultant coating film was measured using a haze meter (Haze-gard plus illuminant CIE-C) manufactured by Gardner. The transparency of the coating film was evaluated by the following criteria:

AA: The total light transmittance was above 80%.

BB: The total light transmittance was in the range of 60-80%

CC: The total light transmittance was less than 60%

(3) Photocatalytic Performance:

Nonwoven fabric was coated with the photocatalytic coating composition.

The nonwoven fabric was each placed in a 1-liter glass vessel, to which 600 ppm of acetaldehyde was added. Visible light was selectively applied (at 1.8 mW/cm²) using a fluorescent lamp (FL10N, manufactured by Matsushita Electric Industrial Co., Ltd.) while ultraviolet lights having wavelengths of 410 nm or less were filtered out with a filter (SC42, manufactured by FUJI PHOTO FILM CO., LTD.), and acetaldehyde was decomposed at 25° C. The concentration of carbon dioxide from the acetaldehyde decomposition was measured with a gas chromatograph connected with a methanizer (trade names: GC-14 BandMNT-1, respectively, manufactured by Shimadzu Corporation).

### Synthetic Example 1

Titanium oxide powder (ST01, available from ISHIHARA SANGYO KAISHA, LTD.) having a primary particle diameter of 7 nm was heat-treated in an ammonia-containing atmosphere at 600° C. to give visible light-sensitive photocatalytic powder A (primary particle diameter: 19 nm)

### Synthetic Example 2

A mixture of titanium oxide powder (STO, available from ISHIHARA SANGYO KAISHA, LTD.) having a primary particle diameter of 7 nm and urea capable of adsorbing to titanium oxide at ordinary temperature, was heated at temperatures in the range of 250 to 350° C. to give visible light-sensitive photocatalytic powder B.

### Example 1

A container was charged with 60 parts of the visible light-sensitive photocatalytic powder A prepared in Synthetic Example 1 as photocatalytic material (a), 32 parts of decamer of tetra-n-butoxy titanium (trade name: B-10, available from NIPPON SODA CO., LTD.) as titanium compound (b), 200 parts of methyltrimethoxysilane as silane compound (c), 41 parts of epoxy/polyoxyalkylene/alkoxy-modified dimethylpolysiloxane (MAC-2101, available from Nippon Unicar Co., Ltd.) as organosiloxane oligomer (d), and 44 parts of isopropyl alcohol as organic solvent (e). Further, 300 parts of 0.3 mm-diameter zirconia beads were added. These components were stirred using a bead mill at 1500 rpm for 1 hour to disperse them. Subsequently, 577 parts of i-propyl alcohol as organic solvent (e) was added. After the beads had been removed, 10 parts of di-i-propoxy ethylacetoacetate aluminum as catalyst (f) and 50 parts of water (e) were added, followed by stirring at 60° C. for 4 hours. Thus, a photocatalytic coating composition A with a solid concentration of about 20% was obtained. The composition A had storage stability of “A” and transparency of “A”.

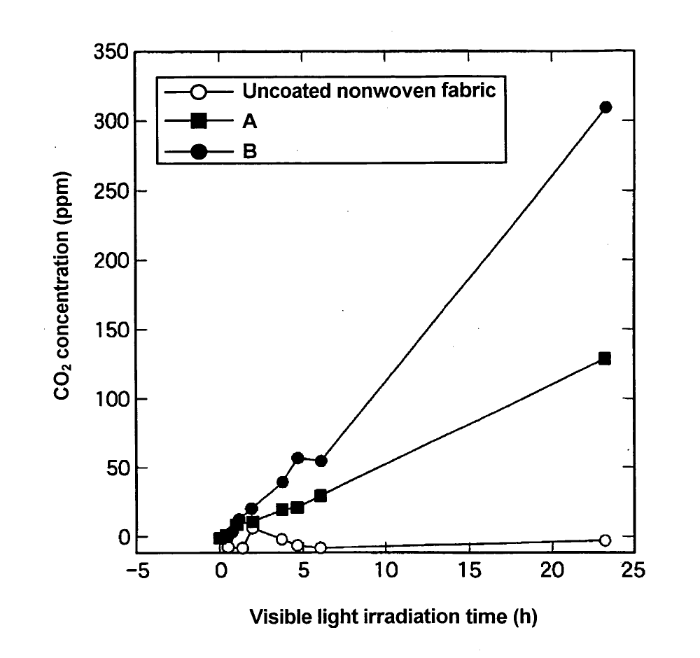

The photocatalytic coating composition A was applied onto a nonwoven fabric and was tested for photocatalytic performance. The results are shown in FIG. 1. An uncoated nonwoven fabric generated no carbon dioxide, but the nonwoven fabric coated with the photocatalytic coating composition A generated carbon dioxide when irradiated with visible light. Thus, photocatalytic effects were observed.

### Example 2

A photocatalytic coating composition B with a solid concentration of about 20% was obtained in a similar manner as in Example 1, except that 60 parts of the visible light-sensitive photocatalytic powder B prepared in Synthetic Example 2 was used as the photocatalytic material (a). The composition B had storage stability of “A” and transparency of “A”.

The photocatalytic coating composition B was tested for photocatalytic performance as described in Example 1. As indicated in FIG. 1, photocatalytic effects were observed with respect to a nonwoven fabric coated with the photocatalytic coating composition B.

### Comparative Example 1

A container was charged with 60 parts of the visible light-sensitive photocatalytic powder A prepared in Synthetic Example 1 as photocatalytic material (a), 200 parts of methyltrimethoxysilane as silane compound (c), 41 parts of MAC-2101 as organosiloxane oligomer (d), and 44 parts of i-propyl alcohol as organic solvent (e). Further, 300 parts of 0.3 mm-diameter zirconia beads were added. These components were stirred using a bead mill at 1500 rpm for 1 hour to disperse them. Subsequently, 545 parts of i-propyl alcohol as organic solvent (e) was added. After the beads had been removed, 10 parts of di-i-propoxy ethylacetoacetate aluminum as catalyst (f) and 50 parts of water (e) were added, followed by stirring at 60° C. for 4 hours. Thus, a photocatalytic coating composition C with a solid concentration of about 20% was obtained. The storage stability thereof was very bad and standing for 1 hour resulted in separation and sedimentation (storage stability: “C”). The evaluation of transparency was “C”.

Coating with the photocatalytic coating composition C failed to produce a uniform coating film.

### INDUSTRIAL APPLICABILITY

The present invention can provide the photocatalytic coating compositions that can give coating films which exhibit adequate photocatalytic action even in an environment with less spectral components having wavelengths of 400 nm or below and more visible light, for example in an indoor environment and in vehicle interiors having UV protection glass, and which have high transparency; and that also have good storage stability of dispersions. Further, the coating films obtained from the photocatalytic coating compositions can be suitably used in wide applications including decomposition of organic matters, taking advantage of photocatalytic performance.

1. A photocatalytic coating composition comprising:
(a) at least one visible light-sensitive photocatalytic material selected from the group consisting of (i) photocatalytic materials obtained by substituting a nitrogen atom for part of the oxygen sites of a metal oxide crystal, (ii) photocatalytic materials obtained by doping a nitrogen atom at an interstitial site of lattices of a metal oxide crystal, and (iii) photocatalytic materials obtained by doping a nitrogen atom between grain boundaries of polycrystalline aggregates of a metal oxide crystal;
(b) at least one titanium compound selected from the group consisting of organotitaniums represented by the following formula (1) and derivatives thereof:
R¹ₘTi(OR²)₄₋ₘ (1)
wherein R¹ is an organic group of 1 to 8 carbon atoms and may be the same or different from each other when plural; R² is an organic group selected from the group consisting of alkyl groups of 1 to 6 carbon atoms, acyl groups of 1 to 6 carbon atoms and phenyl group, and may be the same or different from each other when plural; R¹ and R² may be the same or different; and m is an integer ranging from 0 to 3;
(c) at least one silane compound selected from the group consisting of organosilanes represented by the following formula (2) and derivatives thereof:
R³Si(OR⁴)₄₋ₙ (2)
wherein R³ is a monovalent organic group of 1 to 8 carbon atoms and may be the same or different from each other when plural; R⁴ is an alkyl group of 1 to 5 carbon atoms or an acyl group of 1 to 6 carbon atoms, and may be the same or different from each other when plural; R³ and R⁴ may be the same or different; and n is an integer ranging from 0 to 3;
(d) an organosiloxane oligomer that has an Si—O linkage and a weight-average molecular weight of 300 to 100,000, said organosiloxane oligomer containing a structure represented by the following formula (3):
(R⁵O)ₚ—(R⁶O)_{q}—R⁷ (3)
wherein R⁵ and R⁶ are each an alkyl group of 1 to 5 carbon atoms and may be the same or different; R⁷ is a hydrogen atom or an alkyl group of 1 to 5 carbon atoms; and p and q are numbers of which the total (p+q) is in the range of 2 to 50; and
(e) water and/or an organic solvent.

2. The photocatalytic coating composition according to claim 1 further comprising a catalyst (f) capable of accelerating hydrolysis and condensation of the silane compound (c).

3. The photocatalytic coating composition according to claim 1 or 2, wherein part of metal atoms of the metal oxide in the photocatalytic material (a) forms a chemical bond with the nitrogen atom.

4. The photocatalytic coating composition according to any one of claims 1 to 3, wherein the metal oxide is titanium oxide.

5. A coating film obtained from the photocatalytic coating composition described in any one of claims 1 to 4, wherein the coating film comprises the photocatalytic material (a), polytitanoxane and polysiloxane.

6. The coating film according to claim 5, wherein the photocatalytic material (a) is adjacent to the polytitanoxane and is dispersed in the polysiloxane through the polytitanoxane.
